(19) United States
(12) Patent Application Publication
(10) Pub. No.: US 2025/0297857 A1
(43) Pub. Date: Sep. 25, 2025

(54) Gyroscopic measurement method and sensor

(71) Applicant: THALES, Meudon (FR)

(72) Inventors: Nicolas Paul MARTIN, VALENCE CEDEX (FR); Nicolas Jean-Marc Frédéric VERCIER, VALENCE CEDEX (FR)

(21) Appl. No.: 18/788,297

(22) Filed: Jul. 30, 2024

(30) Foreign Application Priority Data
Mar. 25, 2024 (FR) 2402944

(51) Int. Cl. G01C 19/5776; G01C 19/00

(52) U.S. Cl. CPC G01C 19/5776; G01C 19/005

(57) ABSTRACT

The present invention relates to a gyroscopic measurement method by means of a sensor (10) comprising a housing (12) and a vibrating element (15) able to vibrate relative to the housing (12) simultaneously according to a direction (x) of a pilot mode and a direction (y) of a detection mode, comprising the control (110) of a first and a second vibration amplitude of the vibrating element (15) according to the directions of the pilot mode and detection mode respectively to a predetermined pilot amplitude (xₘₐₓ) and detection amplitude (yₘₐₓ), and the determination (120) of an instantaneous angular speed (Ωₘₑₛ) of the housing (12).

A predetermined bias (ξ(t)) is introduced into a measurement of an angular position (θ) of the direction (x) of the pilot mode used to determine a biased force (F_{ass,bias}) to be exerted on the vibrating element (15) for the control of the first and/or second vibration amplitude, to cause controlled rotation of the direction (x) of the pilot mode in the plane of vibration (XY).

### BACKGROUND OF THE DISCLOSURE

### Field of the Disclosure

The present invention relates to a gyroscopic measurement method.

The invention also relates to a gyroscopic sensor for implementing the gyroscopic measurement method, as well as to a computer program comprising instructions which cause the sensor to execute the step of determining the instantaneous angular speed of the gyroscopic sensor of this method.

### Description of Related Art

A Coriolis Vibratory Gyroscope (CVG) allows to measure the component along an axis, called the sensitivity axis, of an instantaneous speed of rotation vector of a reference frame, attached to a sensor housing relative to an inertial reference frame.

To this end, the CVG comprises a vibrating sensor element able to vibrate relative to the housing. The measurement is carried out thanks to the effects of the inertial Coriolis force exerted on the vibrating element.

The vibrating element of a CVG is able to vibrate according to two coplanar and perpendicular vibration directions, called the direction of the pilot mode and the direction of the detection mode, the work of the Coriolis force allowing a transfer of mechanical energy between the two directions.

The sensitivity axis of the CVG is orthogonal to the plane of the perpendicular directions of the pilot mode and the detection mode.

For the measurements, the vibrating element is excited according to the direction of the pilot mode at its resonant frequency by the excitation system. The amplitude of the vibrations according to the pilot mode is kept constant by means of an amplitude control applied to the excitation system. Any variations in the resonant frequency, in particular due to variations in the temperature of the vibrating element, are monitored by means of a frequency control system.

If the component according to the sensitivity axis of the instantaneous rotation velocity vector of the housing relative to an inertial reference frame is non-zero, the displacement of the vibrating element according to the direction of the pilot mode generates a Coriolis force. This Coriolis force excites the vibrating element according to the direction of the detection mode, perpendicular to the direction of the pilot mode, to an amplitude which is proportional to the component according to the sensitivity axis of the instantaneous rotation velocity vector.

A CVG can operate according to two modes: the gyroscope mode and the gyrometer mode.

In the gyroscope mode, the position of the direction of the pilot mode in the plane of vibration is free. The instantaneous rotation speed to be measured is then deduced from the angular position of the vibrating element of the plane of vibration in the reference frame attached to the housing.

In the gyrometer mode, the direction of the pilot mode in the plane of vibration is servoed by sending an electronic command, and the instantaneous rotation speed to be measured is deduced from the force to be exerted to control this direction.

Whether the CVG is used in gyroscope mode or gyrometer mode, measurements are subject to intrinsic errors due to CVG defects. Among these defects can be mentioned anisotropies in the stiffness or damping of the vibrating element, defects in the excitation control electronics or in the electronics detecting the position of the vibrating element, defects in the electrical reference voltage for the excitation, and so on.

Among these errors, some are so-called harmonic, as they are proportional to cosine or sine functions of an even multiple angle of the angle characterizing the direction of the pilot mode in the reference frame attached to the housing.

U.S. Pat. No. 6,598,455 describes a gyroscopic measurement method in which the geometric vibration position of the gyroscope is voluntarily modified by electrostatic means over time, in order to improve gyroscope calibration.

Furthermore U.S. Pat. No. 7,093,370 describes a MEMS gyrometer in which an angular speed is voluntarily imposed on the sensor by mechanical means, the direction of rotation of the sensor being periodically alternated with the aim of reducing measurement errors and in particular gyrometer scale factor errors.

FR 2937414 describes a vibrating gyroscope which combines the principles of patents U.S. Pat. No. 6,598,455, by injecting an electronic signal to make the vibration wave rotate, and U.S. Pat. No. 7,093,370, by imposing a periodically alternating electrical rotation allowing harmonic errors to be minimized. The command signal is able to make the geometric vibration position of the gyroscope rotate in a first direction for part of the command signal period according to a first speed profile, and then in an opposite direction according to a second speed profile. The vibrating gyroscope then provides a corrected signal based on the difference between the measurement signal and the command signal.

However, due to errors in the conversion chain from command signal into electrostatic force, the force actually applied to the vibrating element of the gyroscope to obtain its alternating rotation is different from the force that should theoretically be obtained from the command signal.

If the errors in the conversion chain are perfectly stable over time, the error committed in the angle measurement may be zero over a period characteristic of the variations in the command signal.

However, this is highly unlikely, as there are many different sources of error. These include, in particular, detection errors in the detection combs, excitation errors in the excitation combs, as well as instabilities in the reference voltage used to operate these combs, and errors in the electronic boards that coordinate the implementation of the gyroscopic measurement method.

In the end, in most situations, the average value of the error committed is not zero over one period of the alternating rotation of the sensor position in the reference frame attached to the sensor housing.

Furthermore, during the round trip of the wave, the greater the aforementioned defects, the greater are the angular errors of the sensor.

Such a device reduces the impact of defects on the measurement without, however, allowing the measurement error linked to these defects to be evaluated.

In addition, the command signal used in FR 2937414 should allow the return to the same angular position between the start and end of the control period. In cases where the gyroscope is in motion in the inertial reference frame and not at rest, such a signal will not allow a zero mean control signal to return to the same angular position at the same time.

### BRIEF SUMMARY OF THE DISCLOSURE

One aim of the invention is therefore to propose a gyroscopic measurement method in which alternating rotation of the directions of the pilot and detection modes of the gyroscopic sensor is controlled, and in which measurement errors, particularly the scale factor error, are reduced. To this end, the invention relates to a gyroscopic measurement method by means of a sensor comprising a housing and a vibrating element able to vibrate relative to the housing in a plane of vibration attached to the housing simultaneously according to a direction of a pilot mode and according to a direction of a detection mode different from the direction of the pilot mode, the method comprising the following steps of:
a) servoing a first vibration amplitude of the vibrating element according to the direction of the pilot mode to a predetermined pilot amplitude, and a second vibration amplitude of the vibrating element according to the direction of the detection mode to a predetermined detection amplitude, and
b) determining an instantaneous angular speed of the housing relative to a sensitive axis of the sensor from measurements of the vibrations of the vibrating element and the pilot amplitude,
   the method being characterized in that a predetermined bias is introduced into a measurement of an angular position of the direction of the pilot mode used to determine a biased force to be exerted on the vibrating element for servoing the first and/or second vibration amplitude,
   the introduction of the predetermined bias causing a controlled rotation of the direction of the pilot mode in the plane of vibration,
   the instantaneous angular speed of the housing being further determined from the predetermined bias.

The introduction of a predetermined bias during the method results in an amplitude control force that no longer has the direction of the pilot mode, as in prior art methods, but an offset direction. The offset is a function of the bias introduced.

This offset means that the force exerted for servoing the amplitude has a component orthogonal to the direction that would be desired in the absence of bias, which is added to the Coriolis force due to the movement in rotation of the housing relative to the inertial reference frame. A rotation of the perpendicular directions of the pilot mode and of the detection mode is caused, without the need for an additional force, the accuracy of which would be difficult to control.

The bias can also be a predetermined function of time. If this function is carefully chosen, it is possible to cancel out harmonic errors in the sensor on which the method is implemented.

The gyroscopic measurement method according to the invention therefore allows gyroscopic measurements to be carried out with increased precision.

According to other advantageous aspects of the invention, the gyroscopic measurement method comprises one or more of the following features, taken alone or according to any technically possible combination:
the predetermined bias is configured to cause a rotation of the direction of the pilot mode by a predetermined angle alternately in a first direction and in a direction opposite to the first direction;
the predetermined angle is equal to 90°;
the detection amplitude is chosen to be zero;
the control step comprises:
1) a measurement of the vibrations of the vibrating element;
2) an estimation of a characteristic phase of the vibrations of the vibrating element according to the direction of the pilot mode from the results of the measurement;
3) a first estimation of a first force, the direction of which is the direction of the pilot mode, to be exerted on the vibrating element to servo the first amplitude, from the results of the measurement and the estimated phase;
4) a second estimation of a second force the direction of which is the direction of the pilot mode to be exerted on the vibrating element to servo the second amplitude, from the results of the measurement and the estimated phase;
5) introduction of the predetermined bias in the directions of the first force and of the second force;
6) control of the biased force which is equal to the resultant of the first force and the second force after introduction of the predetermined bias in the directions of these two forces;
the second force comprises only a component in phase with the vibrations of the vibrating element according to the direction of the pilot mode.

The invention also relates to a gyroscopic sensor comprising a housing and a vibrating element able to vibrate relative to the housing in a plane of vibration attached to the housing simultaneously according to a direction of a pilot mode and according to a direction of a detection mode different from the direction of the pilot mode and configured to implement the steps of the method according to any of the preceding embodiments.

According to other advantageous aspects of the invention, the gyroscopic sensor comprises one or more of the following features, taken alone or in any technically possible combinations:
the sensor comprises:
a) a first control module, configured to estimate a first force to be exerted according to the direction of the pilot mode in order to servo a first vibration amplitude of the vibrating element according to the direction of the pilot mode to a predetermined pilot amplitude;
b) a second control module, configured to estimate a second force to be exerted according to the direction of the detection mode in order to servo a second amplitude of vibration of the vibrating element in the direction of the detection mode to a predetermined detection amplitude;
c) a measurement module, configured to generate measurements of the vibrations of the vibrating element in two directions of a reference frame attached to the housing, said two directions being contained in the plane of vibration;
d) a command module, configured to determine a biased force to be exerted on the vibrating element for the servoing of the first and/or second vibration amplitude, from the first force and the second force and from a biased angular position of the direction of the pilot mode in the reference frame attached to the housing which corresponds to an angular position of the direction of the pilot mode in the reference frame attached to the housing after introduction of a predetermined bias, and to exert the biased force;
e) a bias device, configured to supply the biased angular position to the command module from measurements of the vibrations of the vibrating element according to the two directions of the reference frame attached to the housing and from the predetermined bias, the introduction of the predetermined bias being configured to cause controlled rotation of the direction of the pilot mode in the plane of vibration when the biased force is exerted; and
f) a determination module, configured to determine an instantaneous angular speed of the housing relative to a sensitive axis of the sensor from measurements of the vibration of the vibrating element, from the pilot amplitude and from the predetermined bias;
the bias device comprises:
1) a reference frame change module, configured to generate estimations of the vibrations of the vibrating element according to the direction of the pilot mode and the direction of the detection mode, from measurements of the vibrations of the vibrating element according to the two directions of the reference frame attached to the housing, supplied by the measurement module, and from the biased angular position supplied by a correction module of the bias device;
2) a phase module, configured to receive as input estimations of the vibrations of the vibrating element according to the direction of the pilot mode from the reference frame change module and to estimate a phase characterizing a position of the vibrating element according to the direction of the pilot mode at a current date;
3) a precession module, configured to receive the estimations of the vibrations of the vibrating element according to the directions of the pilot mode and the detection mode from the reference frame change module and the phase from the phase module, and to supply as an output an estimated difference between the angular position of the direction of the pilot mode in the reference frame attached to the housing at the current date and a biased angular position previously supplied by the corrector module, and
4) the correction module, configured to supply the biased angular position to the command module from the estimated difference, the correction module comprising:
i) a sum module, configured to add the predetermined bias to said estimated difference; and
ii) a feedback loop to the reference frame change module, the feedback loop comprising a gain module and an integration module,
   the correction module being configured so that the estimated difference converges to a zero value.

The invention also relates to a computer program comprising instructions which cause the sensor, according to any of the preceding embodiments, to execute the method according to any one of the embodiments described above.

### BRIEF DESCRIPTION OF THE SEVERAL VIEWS OF THE DRAWING(S)

The invention will become clearer on reading the following description, given solely by way of non-limiting example, and made with reference to the drawings in which:

FIG. 1 is a schematic representation of a part of the elements of one embodiment of a CVG according to the invention, including the vibrating element and the devices for detecting and exciting this vibrating element;

FIG. 2 is a schematic representation of the trajectory of the vibrating element of FIG. 1 and of the directions of its pilot mode and detection mode in a reference frame attached to the housing;

FIG. 3 is a partial representation of a CVG implementation mode, complementary to the representation in FIG. 1;

FIG. 4 is a flowchart representation of the method according to the invention;

FIG. 5 is a schematic representation of a prior art CVG;

FIG. 6 is a schematic representation of one embodiment of an excitation device of FIG. 1; and

FIG. 7 shows one particular embodiment of the correction module of FIG. 3.

### DETAILED DESCRIPTION OF THE DISCLOSURE

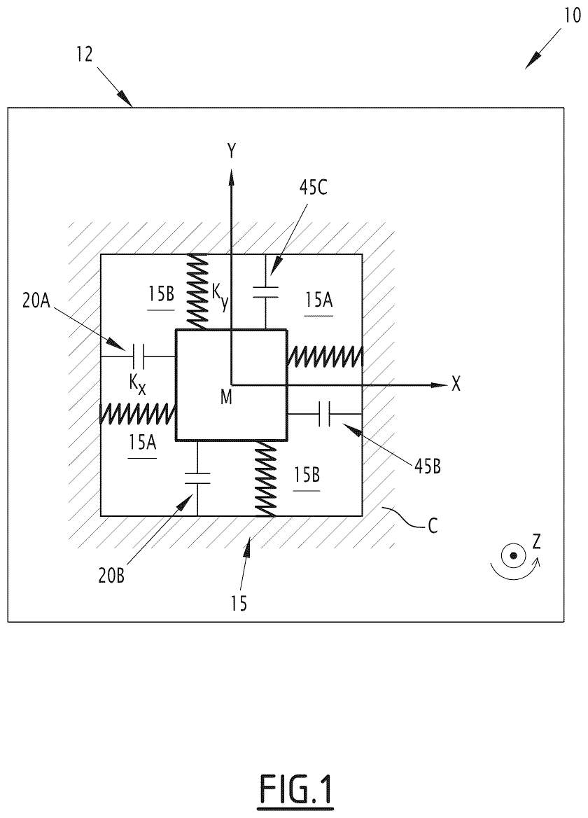

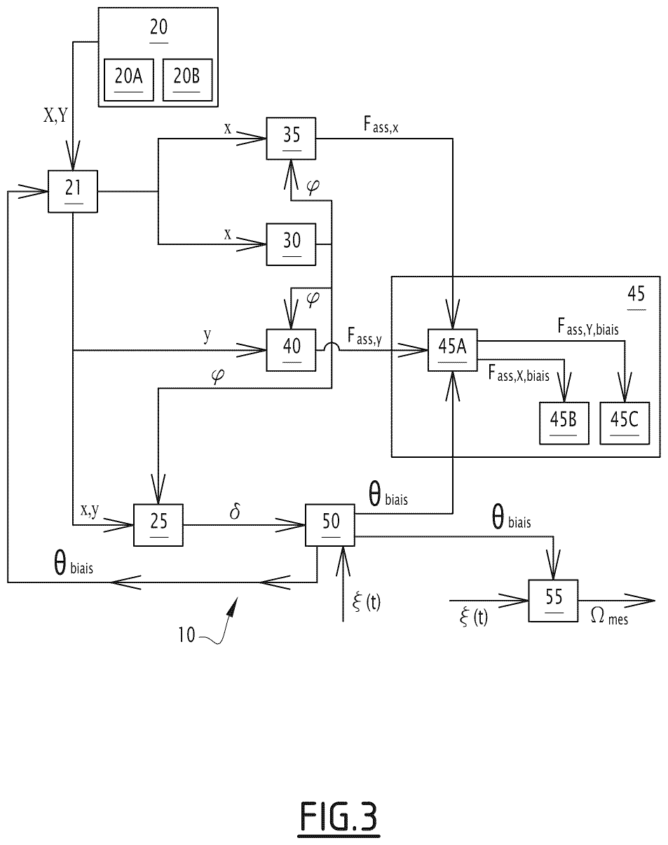

The Coriolis gyro sensor 10, hereinafter referred to as CVG, is described, according to the invention, with reference to FIGS. 1 and 3.

The CVG 10 includes a housing 12 and a vibrating element 15 able to vibrate relative to the housing 12.

The CVG 10 is made, for example, in the form of a microelectromechanical sensor (MEMS). The vibrating element 15 and the housing 12 are then cut into a block of silicon or quartz by micromachining, and the vibrating element 15 is set into vibration by an electrical method. This arrangement allows to minimize the size and/or manufacturing cost of the CVG 10.

Three axes X, Y, Z of the space coordinate frame XYZ of a reference frame (XYZ, t) attached to the housing 12 are represented in FIG. 1, the Z axis being of fixed direction in a space coordinate frame of an inertial frame of reference.

The CVG 10 is configured to measure an instantaneous angular speed Ω(t) of the sensor relative to the Z axis, which therefore constitutes the sensitivity axis (or equivalently the sensitive axis) of the CVG 10.

To this end, the vibrating element 15 comprises a test mass M, able to vibrate in the XY plane according to two directions x and y, with a natural angular frequency ω₀ₓ, respectively ω_{0y} close to ω₀ₓ.

In the following, the direction x is considered to be the direction of the pilot mode and the direction y is the direction of the detection mode. The direction y of the detection mode is perpendicular to the direction x of the pilot mode.

The test mass M is able to vibrate according to the direction x of the pilot mode and the direction y of the detection mode, with a resonance angular frequency ω close to ω₀ₓ.

The CVG 10 includes a measurement module 20 able to generate measurements of the vibrations of the vibrating element 15 according to the X and Y directions of the reference frame attached to the housing 12.

In particular, the measurement module 20 is able to measure the position X(t) (respectively Y(t)) of the vibrating element 15, and/or indirectly its speed dX/dt(t) (respectively dY/dt(t)), and/or indirectly its acceleration d²X/dt²(t) (respectively d²Y/dt²(t)) according to the direction X (respectively according to the direction Y) of the reference frame attached to the housing 12.

To this end, the measurement module 20 may comprise suitable detection means, such as, for example, electrostatic detection means 20A according to the direction X of the reference frame attached to the housing 12 and electrostatic detection means 20B according to the direction Y of the reference frame attached to the housing 12.

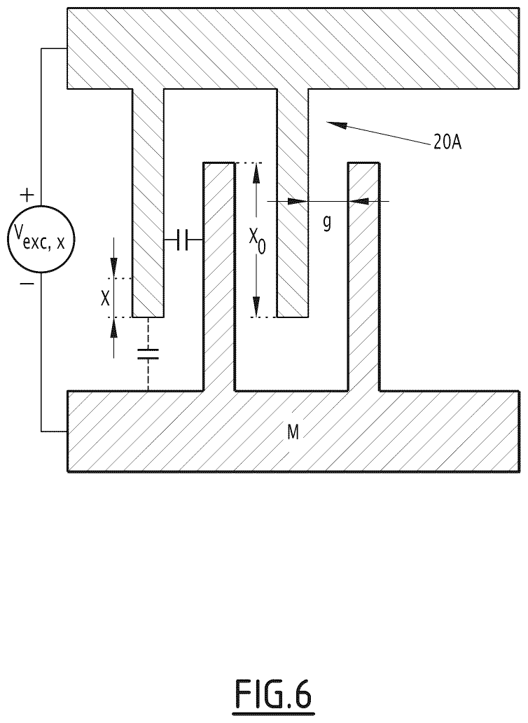

Advantageously, the electrostatic detection means 20A and 20B each form with the test mass M a set of interdigitated combs, on the geometric principle represented in FIG. 6.

Advantageously, the measurement module 20 comprises a proximity board configured to amplify the signals detected by the measurement module 20.

The measurement module 20 is able to transmit the measurements of the vibrating element to a reference frame change module 21.

The reference frame change module 21 is able to generate estimations of the vibrations of the vibrating element 15 according to the directions x of the pilot mode and y of the detection mode, from measurements of the vibrations of the vibrating element according to the directions X and Y of the reference frame attached to the housing 12 and from a biased estimate θ_{biais} of an angular position θ of the direction x of the pilot mode in the reference frame attached to the housing 12 received from a corrector module 50 which will be described later.

In particular, the reference frame change module 21 is able to estimate the position x(t) (respectively y(t)) of the vibrating element 15 and/or indirectly its speed dx/dt(t) (respectively dy/dt(t)) and/or indirectly its acceleration d²x/dt²(t) (respectively d²y/dt²(t)) according to the direction x of the pilot mode (respectively according to the direction y).

The reference frame change module 21 is able to transmit the generated estimations to a phase module 30, a first control module 35 and a second control module 40.

The phase module 30 is configured to estimate a phase φ(t) characterizing the position of the mass M according to the direction x of the pilot mode at the current date t. For example, the phase φ(t) is of the form φ(t)=ωt+φ₀, where φ₀ designates a phase at the origin of dates t.

The phase module 30 is configured to receive as input estimations of the position of the mass M according to the direction x of the pilot mode from the reference frame change module 21.

The phase module 30 is configured to transmit the estimated phase φ(t) to the first control module 35 and to the second control module 40.

The first control module 35 is configured to estimate, from the estimations of the vibrations of the vibrating element 15 according to the direction x of the pilot mode and the phase φ(t), a first force F_{ass,x} the direction of which is the direction x of the pilot mode. The first force F_{ass,x} is the force that must be exerted on the vibrating element 15 to servo a first amplitude characteristic of the vibrations of the vibrating element 15 to a predetermined non-zero pilot amplitude xₘₐₓ, the vibrating element 15 vibrating in sinusoidal state, at the resonance angular frequency ω, according to the direction x of the pilot mode.

The first control module 35 is configured to transmit the estimated first force F_{ass,x} to a command module 45, which will be described later.

The first control module 35 comprises, for example, a processor or a programmable logic circuit (such as a Field Programmable Gate Array, FPGA), configured to manage the estimation of the first force F_{ass,x}, as well as a proximity board configured to transmit this estimation to the command module 45.

The second control module 40 is able to estimate, from estimations of the vibrations of the vibrating element 15 according to the direction y of the detection mode transmitted by the reference frame change module 21 and of the phase φ(t) a second force F_{ass,y}, the direction of which is the direction y of the pilot mode. The second force F_{ass,y} is the force that must be exerted to servo a second amplitude characteristic of the vibrations of the vibrating element 15 according to the direction y of the detection mode to a detection amplitude yₘₐₓ, the vibrating element 15 vibrating in sinusoidal mode according to the direction y of the detection mode at the resonance angular frequency ω.

The second control module 40 is configured to transmit the estimated second force F_{ass,y} to the command module 45.

The second control module 40 comprises, for example, a processor or programmable logic circuit, such as an FPGA.

The processor or programmable logic circuit of the second control module 40 may be the same as that of the first control module 35. This arrangement is advantageous but not mandatory.

The proximity board of the second control module 40 is, for example, the same as that of the first control module 20. This arrangement is advantageous but not mandatory.

The command module 45 is configured to:
a) determine a third biased force F_{ass,X,bias} and a fourth biased force F_{ass,Y,bias} to be actually exerted according to the direction X and the direction Y of the reference frame XYZ attached to the housing 12, from:
   the first estimated force F_{ass,x},
   the second estimated force F_{ass,y}, and
   a biased angular position θ_{biais} of the direction x of the pilot mode, and
b) to actually exert the third biased force F_{ass,X,bias} and the fourth biased force F_{ass,Y,bias} on the vibrating element 15.

The command module 45 comprises, for example, a processor or programmable logic circuit 45A, such as an FPGA, configured to determine the third biased force F_{ass,X,bias} and the fourth biased force F_{ass,Y,bias}.

The command module 45 comprises means 45B and 45C for exciting the vibrating element 15 according to the direction X and the direction Y respectively of the reference frame XYZ attached to the housing 12.

These means are not shown in detail in FIGS. 1 and 3. They are, for example, the excitation means described in document EP2960625.

By way of example, the excitation means 45B comprise an electrostatic device configured to exert on the vibrating element 15 the third biased force F_{ass,X,bias} according to the direction X of the reference frame XYZ attached to the housing 12.

By way of example, the excitation means 45C comprise an electrostatic device configured to exert on the vibrating element 15 the fourth biased force F_{ass,Y,bias} according to the direction Y of the reference frame XYZ attached to the housing 12.

The electrostatic device of the excitation means 45B and/or 45C and the test mass M of the vibrating element 15 form, for example, a set of interdigitated combs, as represented in FIG. 6.

In this case, the command module 45 advantageously comprises a proximity board, configured to inject an amplitude command signal into each of the electrostatic devices of the excitation means 45B and/or 45C.

The processor or programmable logic circuit of the command module 45 is advantageously configured to manage the control of the vibration angular frequency of the vibrating element 15 according to the direction y of the detection mode, for example at the resonance angular frequency ω.

The command module 45 receives the biased angular position θ_{biais} of the direction x of the pilot mode from a correction module 50.

The correction module 50 is configured to receive from the precession module 25 an estimated difference δ between the angular position θ of the direction x of the pilot mode estimated by the precession module 25 and the biased angular position θ_{biais} and a bias function ξ(t), and to output the biased angular position θ_{biais}.

To this end, the correction module 50 comprises a processor or programmable logic circuit (such as an FPGA).

The bias function ξ(t) may be constant or dependent on the date t at which the biased angular position θ_{biais} is calculated.

The biased angular position θ_{biais} of the rotating reference frame is the result of the application of the bias function ξ(t) in the estimation of the angle θ by the correction module 50.

In light of FIG. 3, it is understood that the biased angular position θ_{biais} as output by the correction module 50 is used by the reference frame change module 21. The precession module 25 is used to determine the estimated difference δ supplied as input to the correction module 50.

The estimated difference δ used by the correction module 50 to determine the biased angular position θ_{biais} at a given date t is calculated, among other things, from a biased angular position θ_{biais} measured at a date prior to date t.

The precession module 25, for its part, is configured to receive estimations of the vibrations of the vibrating element 15 according to the directions x of the pilot mode and y of the detection mode from the reference frame change module 21 and the phase φ(t) from the phase module 30, and to output the estimated difference δ.

The precession module 25 constitutes an element of a tracking loop configured to estimate the biased angular position θ_{biais} from one to the next, from a known initial unbiased angular position θᵢₙᵢₜᵢₐₗ and a demodulation of the estimation of the position of the vibrating element 15 according to the directions of the pilot mode and detection mode.

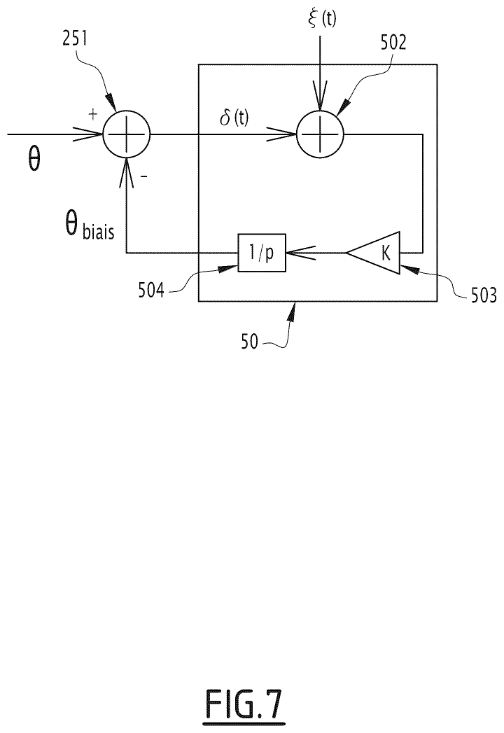

In particular, the tracking loop also comprises the correction module 50, the correction module 50 itself comprising an integration module 504 and a gain module 503 which will be described later with reference to FIG. 7, the variation of the biased angular position θ_{biais} over an integration period T being calculated on the basis of the following equations:

$$\{ \begin{matrix}{I}_{n} = {\int }_{( n - 1 ) T}^{n T} x ( t ) \cdot cos ( φ ( t ) ) dt \\ {Q}_{n} = {\int }_{( n - 1 ) T}^{n T} y ( t ) \cdot cos ( φ ( t ) ) dt \\ {θ}_{b i a i s} ( t + d t ) = {θ}_{b i a i s} ( t ) + K {tan}^{- 1} ( {I}_{n} , {Q}_{n} ) d t\end{matrix}$$

The precession module 25 is able to transmit the estimated difference δ to the correction module 50.

The CVG 10 further comprises a determination module 55 able to determine a measured instantaneous angular speed Ωₘₑₛ(t), which is an estimator of the desired angular speed Ω(t), from the estimated biased angular position θ_{biais} and from the bias function ξ(t).

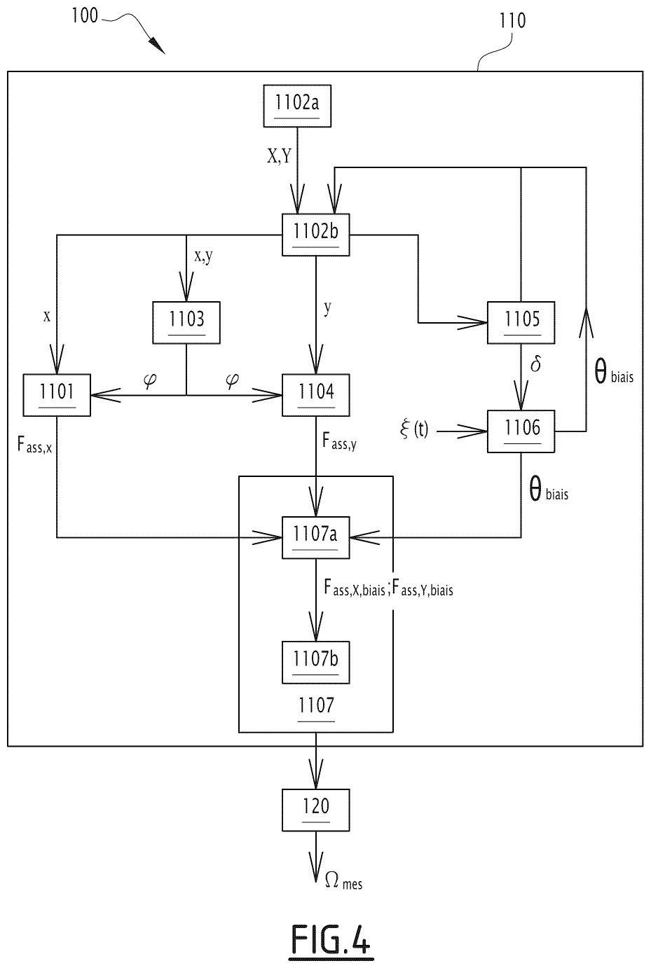

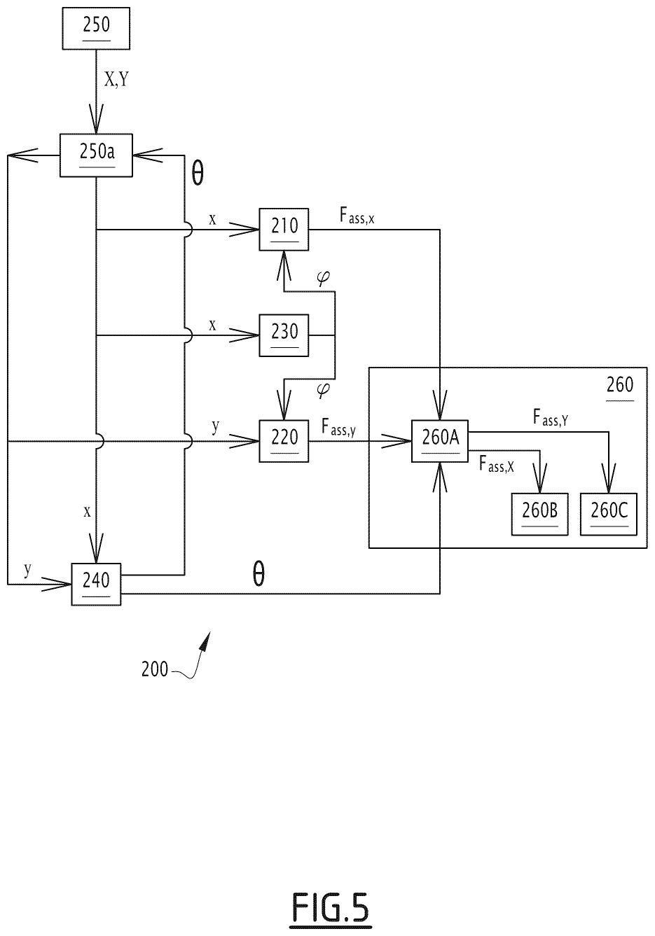

The method 100 according to the invention will now be described with reference to FIG. 4, in comparison with a prior art method 200 implemented on the CVG represented in FIG. 5.

The method 100 according to the invention comprises:
a) a servoing step 110 in which the first amplitude of the vibrations of the vibrating element 15 according to the direction x of the pilot mode is servoed to the predetermined pilot amplitude xₘₐₓ, and the second amplitude of the vibrations of the vibrating element 15 according to the direction y of the detection mode is servoed to the predetermined detection amplitude yₘₐₓ, during which the predetermined bias function ξ(t) is introduced into the measurement of the angular position θ of the direction of the pilot mode used to determine a force Fₐₛₛ to be exerted on the vibrating element for servoing the first and second vibration amplitudes, and
b) the determination 120 of an instantaneous angular speed Ωₘₑₛ of the housing 12 relative to the sensitive axis Z of the sensor 10 from measurements of the vibrations of the vibrating element 15, from the pilot amplitude xₘₐₓ and from the predetermined bias function ξ(t).

The servoing step 110 is represented in detail in FIG. 4.

The servoing step 110 comprises a first calculation step 1101 of the first force F_{ass,x}, the direction of which is the direction x of the pilot mode, to be exerted on the vibrating element 15 to control the first amplitude to the pilot amplitude xₘₐₓ.

The first calculation step 1101 is implemented by the first control module 35.

To do this, the first control module 35 receives, from the reference frame change module 21, the estimations of the vibrations of the vibrating element 15 according to the direction x of the pilot mode. These estimations are made on the basis of measurements previously performed by the measurement module 20 during a measurement step 1102a of the vibrations of the vibrating element 15 and obtained during a reference frame change step 1102b performed by the reference frame change module 21.

The first control module 35 also receives the phase φ previously estimated by the phase module 30 in a phase estimation step 1103 from the measurements of the vibrations of the vibrating element 15 according to the direction x of the pilot mode performed in the measurement step 1102.

Simultaneously, the control step 110 comprises a second step 1104 of estimating the second force F_{ass,y} the direction of which is the direction y of the detection mode to be exerted on the vibrating element 15 to servo the second amplitude to the detection amplitude yₘₐₓ.

The second estimation step 1104 is implemented by the second control module 40 from estimations of the vibrations of the vibrating element 15 according to the direction y of the detection mode from the reference frame change step 1102b and transmitted by the reference frame change module 21, and from the phase φ(t) estimated by the phase module 30 in the phase estimation step 1103.

It should be noted that the fact that the reference frame change module receives the biased angular position θ_{biais} but not the angular position θ has a negligible impact on the accuracy of the estimation of the vibrations of the vibrating element 15 according to the direction x of the pilot mode and the direction y of the detection mode. In particular, the difference between the biased angular position θ_{biais} and the angular position θ of the ellipse described by the oscillation can be limited by choosing an appropriate bias function. The control step 110 further comprises a third estimation step 1105 of the difference δ.

The third estimation step 1105 is implemented by the precession module 25 from the estimations of the vibrations of the vibrating element 15 according to the direction x of the pilot mode and according to the direction y of the detection mode from the reference frame change step 1102b, as well as from the phase φ(t) estimated by the phase module 30.

It should be noted that there is no need for an explicit calculation of the angular position θ to estimate the difference δ. Indeed, this difference is estimated, from one to the next, by the tracking loop comprising the precession module 25 and the correction module 50, from the known initial angular position θᵢₙᵢₜᵢₐₗ.

At the end of the third estimation step 1105, a bias step 1106 is implemented by the correction module 50.

During the bias step 1106, the biased angular position θ_{biais} of the direction of the pilot mode is determined, from one to the next, by the correction module 50 from a difference δ estimated at the previous instant and the bias function ξ(t).

A controller step 1107 is then implemented by the command module 45. The controller step comprises a determination sub-step 1107a and an exercise sub-step 1107b.

During the determination sub-step 1107a, the processor 45A of the command module 45 receives the first force F_{ass,x} estimated during the first estimation step 1101 and the second force F_{ass,y} estimated during the second estimation step 1104.

The processor 45A also receives the biased angular position θ_{biais}.

The processor 45A then determines the third biased force F_{ass,X,bias} and the fourth biased force F_{ass,Y,bias} to be actually exerted according to the direction X and the direction Y of the reference frame XYZ attached to the housing 12 from the first estimated force F_{ass,x}, the second estimated force F_{ass,y}, and the biased angular position θ_{biais} of the direction x of the pilot mode considering that the biased angular position is the actual angular position of the direction x of the pilot mode.

Then, during the exercise sub-step 1107b, the third biased force F_{ass,X,bias} and the fourth biased force F_{ass,Y,bias} are exerted by the excitation means 45B, 45C on the vibrating element 15.

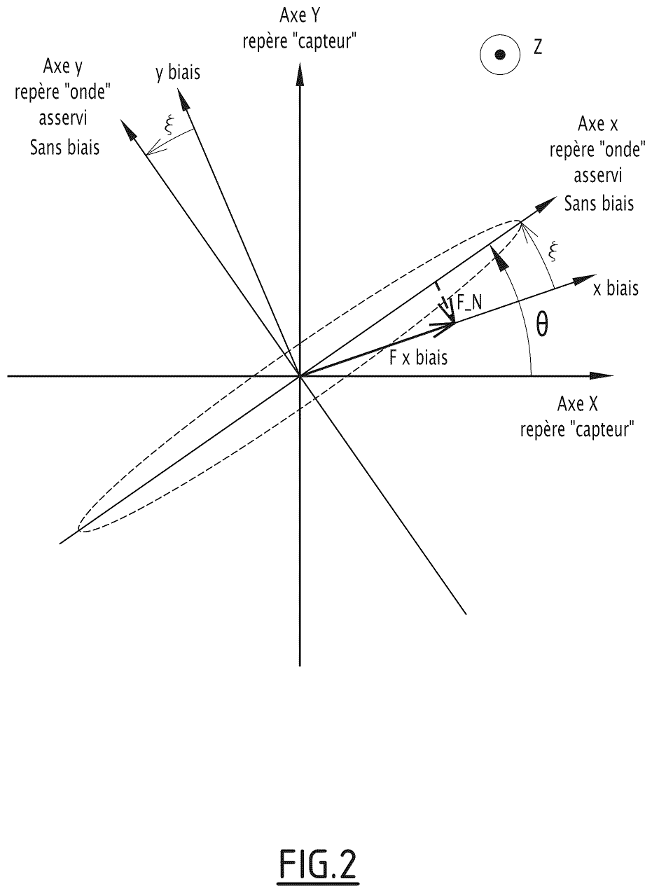

As a result of the introduction of the bias, the resultant of the third biased force F_{ass,X,bias} and the fourth biased force F_{ass,Y,bias} does not have the direction required for the servoing, but a biased direction, as can be seen in FIG. 2.

As a result, an additional rotation of the direction of the detection mode is caused, this rotation being controlled by means of the bias function ξ(t).

This additional rotation is in addition to the rotation caused by the Coriolis force associated with the angular speed Ω(t) we seek to measure.

To better understand the effects obtained during the control step 1107, the operating equations of CVG 10 common to the method 100 according to the invention and to a prior art method will first be described, and then, a prior art method will be described more precisely and finally, the particularities of the method 100 according to the invention will be detailed.

### I) Operating Equations Common to the Method of the Prior Art and the Method According to the Invention

The following section describes the operating equations common to the method of the prior art and to the method according to the invention, equations which underlie the operation of the first and second control modules 35 and 40 and of the command module 45 in the case of the sensor 10 according to the invention.

To simplify the writing of the equations allowing the method of the prior art and the method 100 according to the invention to be understood, the vibrating element 15 will hereinafter be modeled by a mass M suspended on a rigid frame C by means of two pairs of springs 15A, 15B with respective stiffnesses Kx and Ky, as represented in FIG. 1.

Furthermore, in the following, it is considered that the stiffness constants and natural angular frequencies of the vibrating element 15 are identical according to the x and y pilot modes. In this particular case, we can therefore write that Kₓ=K_{y}=K and that ω₀ₓ=ω_{0y}=ω₀.

This simplification should by no means be considered limiting for the operation of the sensor 10 according to the invention, as the equations that follow can be rewritten without difficulty in the most general case.

Generally speaking, the trajectory of the mass M in forced sinusoidal state is an ellipse in the plane (X,Y).

This ellipse is reduced to a straight line segment the direction of which is the direction x of the pilot mode in the case where the vibration amplitude according to the detection mode is controlled to a zero detection amplitude yₘₐₓ.

Without making any assumptions at this stage about the value of the detection amplitude yₘₐₓ, the position x of the mass M according to the direction x of the pilot mode as a function of the date t is of the form x(t)=xₘₐₓ cos(ωt+φ₀) and the position y of the mass M according to the direction y of the detection mode as a function of the date t is of the form y(t)=yₘₐₓ sin(ωt+φ₀).

To simplify writing the equations, the phase at the origin of the dates φ₀ is considered to be zero, without this having any impact on the operation of the method according to the invention.

If the direction x of the pilot mode relative to the X axis of the coordinate frame XYZ attached to the housing 12 is marked by the angle θ represented in FIG. 2, the X and Y coordinates of the mass M in the coordinate frame XYZ attached to the housing 12 are linked to the x and y coordinates of the mass M in the coordinate frame xyZ by equation 1:

$$[ \begin{matrix}X \\ Y\end{matrix} ] = [ \begin{matrix}cos θ & - sin θ \\ sin θ & cos θ\end{matrix} ] [ \begin{matrix}x \\ y\end{matrix} ] = R ( θ ) [ \begin{matrix}x \\ y\end{matrix} ] \qquad ( 1 )$$

where R(θ) is the transformation matrix of the coordinate frame xy to the coordinate frame XY:

$$R ( θ ) = [ \begin{matrix}cos θ & - sin θ \\ sin θ & cos θ\end{matrix} ] \qquad ( 2 )$$

The transformation matrix R(θ) is a function of time if the direction of the pilot mode is not constant in the coordinate frame XYZ attached to the housing 12.

The first time derivatives dX/dt and dY/dt of the coordinates X and Y of the mass M therefore satisfy:

$$[ \begin{matrix}\dot{X} \\ \dot{Y}\end{matrix} ] R ( θ ) [ \begin{matrix}\dot{x} - \dot{θ} y \\ \dot{θ} x + \dot{y}\end{matrix} ] \qquad ( 3 )$$

The second time derivatives d²X/dt² and d²Y/dt² of the coordinates X and Y of the mass M satisfy

$$[ \begin{matrix}\ddot{X} \\ \ddot{Y}\end{matrix} ] = R ( θ ) [ \begin{matrix}\ddot{x} - {\dot{θ}}^{2} x - 2 \dot{θ} \dot{y} - \ddot{θ} y \\ 2 \dot{θ} \dot{x} + \ddot{θ} x + \ddot{y} - {\dot{θ}}^{2} y\end{matrix} ] \qquad ( 4 )$$

In the forced sinusoidal mode at the angular frequency ω, if we ignore the terms that are not proportional to a positive integer power of angular frequency ω in front of the other terms, the equation 4 can be written in the simplified form of equation 5:

$$[ \begin{matrix}\ddot{X} \\ \ddot{Y}\end{matrix} ] = R ( θ ) [ \begin{matrix}\ddot{x} - 2 \dot{θ} \dot{y} \\ 2 \dot{θ} \dot{x} + \ddot{y}\end{matrix} ] \qquad ( 5 )$$

In the reference frame of the housing 12, the mass M is subject to the resultant Fₐₛₛ of the forces exerted by the excitation means 45B, 45C for its control, the component of which according to the direction x of the pilot mode (respectively the direction X of the reference frame attached to the housing 12) is noted F_{ass,x} (respectively F_{ass,X}) and the component according to the direction y of the detection mode (respectively the direction Y of the reference frame attached to the housing 12) is noted F_{ass,y} (respectively F_{ass,Y}).

The mass M is also subject to the restoring forces of the springs, as well as to a damping which is modeled by a fluid friction force according to each of the directions x and y associated with a quality factor Q.

The damping matrix A of the vibrating element 15, taking into account damping anisotropies, is of the form:

$$A = \frac{M {ω}_{0}}{Q} \cdot [ \begin{matrix}1 & 0 \\ 0 & 1\end{matrix} ] + [ \begin{matrix}a 1 & a 2 \\ a 2 & - a 1\end{matrix} ] \qquad ( 6 )$$

The stiffness matrix K1 of the vibrating element 15, taking into account stiffness anisotropies, is of the form:

$${K}_{1} = K \cdot [ \begin{matrix}1 & 0 \\ 0 & 1\end{matrix} ] + [ \begin{matrix}r 1 & r 2 \\ r 2 & - r 1\end{matrix} ] = M {ω}_{0}^{2} [ \begin{matrix}1 & 0 \\ 0 & 1\end{matrix} ] + [ \begin{matrix}r 1 & r 2 \\ r 2 & - r 1\end{matrix} ] \qquad ( 7 )$$

Furthermore, when the reference frame of the housing 12 is moved by a movement in rotation of the component Ω(t) according to the direction Z relative to the inertial reference frame, the mass M, due to its non-zero relative velocity in the reference frame of the housing 12, is subject to a Coriolis force of inertia in this reference frame of the housing 12.

Newton's second law applied to the mass M in the non-Galilean reference frame attached to the housing 12, therefore takes the following form:

$$M [ \begin{matrix}\ddot{X} \\ \ddot{Y}\end{matrix} ] + {K}_{1} [ \begin{matrix}X \\ Y\end{matrix} ] + A [ \begin{matrix}\dot{X} \\ \dot{Y}\end{matrix} ] + 2 Ω [ \begin{matrix}0 & - M \\ M & 0\end{matrix} ] [ \begin{matrix}\dot{X} \\ \dot{Y}\end{matrix} ] = [ \begin{matrix}{F}_{ass , X} \\ {F}_{ass , Y}\end{matrix} ] = R ( θ ) [ \begin{matrix}{F}_{ass , x} \\ {F}_{ass , y}\end{matrix} ] \qquad ( 8 )$$

where F_{ass,X} and F_{ass,Y} respectively designate the component of the resultant Fₐₛₛ of the forces exerted by the excitation means 45B, 45C according to the direction X of the reference frame attached to the housing 12 and according to the direction Y of the reference frame attached to the housing 12.

To simplify the writing of the equations, damping anisotropies and stiffness anisotropies are neglected in the following, without this being limiting for the implementation of the method.

Neglecting the damping and stiffness anisotropies, the above equation, after multiplication by R(−θ), is written as follows:

$$M [ \begin{matrix}\ddot{x} - {\dot{θ}}^{2} x - 2 \dot{θ} \dot{y} - \ddot{θ} y \\ 2 \dot{θ} \dot{x} + \ddot{θ} x + \ddot{y} - {\dot{θ}}^{2} y\end{matrix} ] + \frac{M {ω}_{0}}{Q} [ \begin{matrix}\dot{x} - \dot{θ} y \\ \dot{θ} x + \dot{y}\end{matrix} ] + M {ω}_{0}^{2} [ \begin{matrix}x \\ y\end{matrix} ] + 2 Ω R ( - θ ) [ \begin{matrix}0 & - M \\ M & 0\end{matrix} ] R ( θ ) [ \begin{matrix}\dot{x} \\ \dot{y}\end{matrix} ] = [ \begin{matrix}{F}_{ass , x} \\ {F}_{ass , y}\end{matrix} ] \qquad ( 9 )$$

$$Or :$$

$$M [ \begin{matrix}\ddot{x} - {\dot{θ}}^{2} x - 2 \dot{θ} \dot{y} - \ddot{θ} y \\ 2 \dot{θ} \dot{x} + \ddot{θ} x + \ddot{y} - {\dot{θ}}^{2} y\end{matrix} ] + \frac{M {ω}_{0}}{Q} [ \begin{matrix}\dot{x} - \dot{θ} y \\ \dot{θ} x + \dot{y}\end{matrix} ] + M {ω}_{0}^{2} [ \begin{matrix}x \\ y\end{matrix} ] + 2 M Ω [ \begin{matrix}- \dot{y} \\ \dot{x}\end{matrix} ] = [ \begin{matrix}{F}_{ass , x} \\ {F}_{ass , y}\end{matrix} ] \qquad ( 9 )$$

If we separate, according to the direction x of the pilot mode, the terms in phase or in phase opposition with the position x of the mass M from the terms in quadrature with this position, by decomposing F_{ass,x} into:

$${F}_{ass , x} = {F}_{ass , x , phase} + {F}_{ass , x , quad} \qquad ( 10 )$$

we obtain the following system of equations, with ABS designating the absolute value:

$$\{ \begin{matrix}{F}_{ass , x , phase} = M ( ( - {ω}^{2} + {ω}_{0}^{2} - {\dot{θ}}^{2} ) x - 2 ( \dot{θ} + Ω ) \dot{y} ) & ( 11 a ) \\ {F}_{ass , x , quad} = ( \frac{M {ω}_{0}}{Q} ( \dot{x} - \dot{θ} y ) - M \ddot{θ} y ) & ( 11 b )\end{matrix}$$

in which F_{ass,x,phase} and F_{ass,x,quad} are the amplitudes of the terms of the component F_{ass,x} in phase and in quadrature with the position x of the mass M respectively.

Similarly, if according to the direction y of the detection mode the terms of the component F_{ass,y} in phase or in phase opposition with the position x of the mass M are separated from the terms in quadrature with this position in:

$${F}_{ass , y} = {F}_{ass , y , phase} + {F}_{ass , y , quad} \qquad ( 12 )$$

the following system of equations is obtained:

$$\{ \begin{matrix}{F}_{ass , y , phase} = ( M \ddot{θ} x + \frac{M {ω}_{0}}{Q} ( \dot{θ} x + \dot{y} ) ) & ( 13 a ) \\ {F}_{ass , y , quad} = M ( ( 2 \dot{θ} + 2 Ω ) \dot{x} - ( {\dot{θ}}^{2} + {ω}^{2} - {ω}_{0}^{2} ) y ) & ( 13 b )\end{matrix}$$

In sinusoidal vibration mode at resonance angular frequency ω, if the terms that are not proportional to a positive integer power of angular frequency ω in front of the other terms are neglected, and taking into account the fact that resonance angular frequency ω and natural angular frequency ω₀ are close, we can write:

$$\{ \begin{matrix}{F}_{ass , x , phase} = - 2 M ω ( \dot{θ} + Ω ) \dot{y} & ( 14 a ) \\ {F}_{ass , x , quad} = \frac{M {ω}_{0}}{Q} \dot{x} & ( 14 b ) \\ {F}_{ass , y , phase} = \frac{M {ω}_{0}}{Q} \dot{y} & ( 14 c ) \\ {F}_{ass , y , quad} = ( 2 M ( \dot{θ} + Ω ) ) \dot{x} & ( 14 d )\end{matrix}$$

When the direction of the pilot mode is constant in the reference frame attached to the housing 12, the equation 14a shows that the in-phase component F_{ass,x,phase} of the force F_{ass,x} to be exerted according to the direction x of the pilot mode for the control of the mass M is zero.

The equation 14b shows that the quadrature component F_{ass,x,quad} of the force F_{ass,x} is non-zero and allows to counteract the damping of oscillations according to the direction x of the pilot mode.

The equation 14c shows that, when the vibration amplitude of the mass M according to the direction of the detection mode is controlled to a non-zero detection amplitude yₘₐₓ, the in-phase component F_{ass,y,phase} of the force F_{ass,y} to be exerted according to the direction y of the detection mode for the control of the mass M is also non-zero and allows to counteract the damping of oscillations according to the direction y of the detection mode.

The mass M is in relative equilibrium in the reference frame attached to the housing 12, if the quadrature component F_{ass,y,quad} of the force F_{ass,y} is zero, then the angular rotation speed of the direction x of the pilot mode in the reference frame attached to the housing 12 is the opposite of the angular speed Ω of the housing in the inertial reference frame that is to be measured

### II) Method According to Prior Art

In the method according to the prior art described with reference to the sensor 200 represented in part in FIG. 5, the amplitude xₘₐₓ of the oscillation according to the direction x of the measurement mode is equal to a non-zero constant value, the amplitude yₘₐₓ of the oscillation according to the direction y of the detection mode is zero, and the rotating coordinate (x, y) is aligned with the main axes of the ellipse described by the oscillation, thanks to four control loops, namely an amplitude loop 210, a quadrature loop 220, a phase loop 230 and a precession loop 240.

The amplitude loop 210 is configured to calculate the F_{ass,x} component to be exerted on the mass M according to the direction x of the pilot mode to control its vibrations.

To do this, a processor in the amplitude loop 210 receives as input data on the position of mass M according to the direction x of the pilot mode from a reference frame change module 250a, as well as data on the phase φ(t)=ωt+φ₀ of the position of the mass M according to the direction x of the pilot mode at the current date t.

The data on the position of the mass M according to the direction x of the pilot mode is calculated by the reference frame change module 250a from measurements of the position of the mass M according to the directions X and Y of the reference frame attached to the housing 12 transmitted by a measurement module 250.

The quadrature loop 220 is configured to estimate the F_{ass,y} component to be exerted on the mass M according to the direction y of the detection mode to control its vibrations.

To do this, a processor in the quadrature loop 220 receives as input data on the position of the mass M according to the direction y of the detection mode from the measurement module 250, as well as data on the phase φ(t)=ωt+φ₀ of the position of the mass M according to the direction x of the pilot mode at the current date t.

The data on the position of the mass M according to the direction y of the detection mode is calculated by the reference frame change module 250a from measurements of the position of the mass M according to the directions X and Y of the reference frame attached to the housing 12 transmitted by the measurement module 250.

The phase loop 230 is configured to estimate the phase φ(t)=ωt+φ₀ of the position of the mass M according to the direction x of the pilot mode at the current date t and transmit the estimate to the processors of the amplitude loop 210 and the quadrature loop 220.

To do this, in a phase φ(t) estimation step, the phase loop 230 processor receives as input data on the position of the mass M according to the direction x of the pilot mode, for example from measurements of the position of the mass M according to the direction X of the reference frame attached to the housing 12, performed by the measurement module 250.

The phase φ(t) estimated by means of the phase loop 230 is supplied as input to the amplitude loop 210 and to the quadrature loop 220.

The precession loop 240 is configured to estimate the angular position θ of the direction x of the pilot mode corresponding to the principal axis of the ellipse described by the oscillation.

To this end, in an estimation step of the angular position θ, the processor of the precession loop 240 receives as input information on the position of the mass M according to the direction x of the pilot mode and according to the direction y of the detection mode, for example from measurements of the position of the mass M according to the directions X and Y of the reference frame attached to the housing 12.

In a control step, a processor 260A of a control module 260 then receives the angular position θ, the force F_{ass,x} and the force F_{ass,y} thus estimated and deduces from them the forces F_{ass,X} and F_{ass,Y} to be commanded to the excitation devices 260B, 260C of the mass M according to the directions X and Y of the reference frame attached to the housing 12.

The excitation devices 260B, 260C implement this command so that the force Fₐₛₛ=F_{ass,X}+F_{ass,Y} is actually exerted.

In particular, the equations 14a to 14d show that if the detection amplitude yₘₐₓ is zero, the resultant Fₐₛₛ of the forces F_{ass,X} and F_{ass,Y} actually exerted must be the force F_{ass,x,quad} the direction of which is the direction x of the pilot mode and in quadrature with the vibrations of the vibrating element according to the direction x of the pilot mode.

More precisely,

$$\{ \begin{matrix}{F}_{ass , X} = {F}_{ass , x , quad} cos θ & ( 15 a ) \\ {F}_{ass , Y} = {F}_{ass , x , quad} sin θ & ( 15 b )\end{matrix}$$

### III) Method According to the Invention

In the method 100 according to the invention, the bias ξ(t) is introduced into the estimation of the angular position θ(t) of the direction x of the pilot mode, so that the command module 45 receives a biased angular position θ_{biais}(t) of this direction.

FIG. 7 shows one particular embodiment of the correction module 50, allowing to understand the influence of the bias function ξ(t) on the position of the rotating reference frame in which the first force F_{ass,x} and the second force F_{ass,y} are estimated relative to the actual positions of the directions x of the pilot mode and y of the detection mode.

In the case shown in FIG. 7, the correction module 50 is placed at the output of a comparison module 251 comprising the reference frame change module 21 and the precession module 25.

The correction module 50 receives from the precession module 25 the estimated difference δ(t) between the angular position θ(t) of the direction of the pilot mode and the biased position θ_{biais}(t) of the rotating reference frame used by the command module 45.

The correction module 50 comprises a sum module 502, configured to add the bias function ξ(t) to the estimated difference δ(t).

Finally, the correction module 50 comprises a feedback loop toward the comparator step 251. The feedback loop comprises the gain module 503 and an integration module 504 of the correction module 50.

The correction module 50 is configured so that the input signal to the comparison module 251 converges toward a zero value.

In steady state, due to the introduction of the bias function ξ(t), the estimated difference δ(t) is therefore equal to the opposite of the bias function ξ(t).

It is therefore understood that the biased angle θ_{biais} differs in the method 100 from the angular position of the direction θ of the pilot mode, in contrast to the method of the prior art.

With the exception of their directions, the estimated first force F_{ass,x} and the second force F_{ass,y} are identical to those of the method of the prior art.

In particular, in the simplified case where the detection amplitude yₘₐₓ is zero, only the F_{ass,x,phase} component is non-zero.

Due to the introduction of the bias (t), the transformation matrix of the reference frame xyZ attached to the wave to the reference frame XYZ related to the housing is a biased matrix R(θ_{biais}), so that the third biased force F_{ass,X,bias} and the fourth biased force F_{ass,Y,bias} commanded by the control module 40 are different from the F_{ass,X} and F_{ass,Y} forces of the prior art method.

By way of example, in the simplified case where the detection amplitude yₘₐₓ is zero,

$$\{ \begin{matrix}{F}_{ass , X , biais} = {F}_{ass , x , quad} cos {θ}_{biais} & ( 16 a ) \\ {F}_{ass , Y , biais} = {F}_{ass , x , quad} sin {θ}_{biais} & ( 16 b )\end{matrix}$$

It is therefore understood that the direction of the resultant F_{ass,bias} of the forces exerted to servo the vibrations of the vibrating element 15 is not the necessary direction but a biased direction, that is, the direction of the biased pilot mode in the simplified case where the detection amplitude yₘₐₓ is zero. This is represented in FIG. 2.

In other words, F_{ass,bias} is not perfectly aligned with the direction x of the pilot mode in this simplified case.

The component F_{N} of this resultant F_{ass,bias}, normal to the direction x of the pilot mode, results in rotation of the direction of the pilot mode in the plane of vibration XY, in addition to the rotation imposed by the Coriolis force.

It should be noted that the effect of introducing the bias in the servoing of the second amplitude according to the direction of the detection mode is generally negligible.

Preferably, the bias function remains permanently less than 5° in absolute value, or even below 4°, below 3°, below 2°, or preferably below 1°.

The additional angular rotation speed Δ\dot{θ} imposed by the introduction of the bias is known. In the simplified case where the detection amplitude yₘₐₓ is zero, its expression is:

$$Δ \dot{θ} = \frac{{F}_{ass , x , quad}}{2 m ω {x}_{max}} sin ( ξ ( t ) ) \qquad ( 17 )$$

The force to be exerted to servo the second amplitude thus becomes

$${F}_{ass , y , quad} = ( 2 M ω ( \dot{θ} + Ω - Δ \dot{θ} ) ) \dot{x} \qquad ( 18 )$$

In the determination step 120, the determination module 55 can therefore provide an estimator Ωₘₑₛ of the sought angular speed Ω on the basis of the biased position θ_{biais} estimated from these measurements, as well as from the bias function ξ(t) and from the pilot amplitude xₘₐₓ. In particular, the sought angular speed Ω can be determined on the basis of the following equation:

$${Ω}_{mes} = \frac{( {θ}_{biais} ( t + dt ) - ξ ( t + dt ) ) - ( {θ}_{biais} ( t ) - ξ ( t ) )}{dt} \qquad ( 19 )$$

In a particular embodiment, the bias function ξ(t) is chosen to cause additional rotations of the direction x of the pilot mode by an angle α, alternately in the trigonometric direction and in the anti-trigonometric direction, the direction of rotation being changed at instants tᵢ for integers i.

The angle α can be bounded in absolute value by a predetermined threshold value αₘₐₓ. and is, for example, equal to π/2.

The instants tᵢ can in this case be the successive instants for which the angle α reaches in absolute value the predetermined threshold value αₘₐₓ.

The bias function ξ(t) may be constant and equal in absolute value to a value ξ_{cons} between instants tᵢ and tᵢ₊₁, the sign of the bias function being changed at each new date tᵢ so as to modify the direction of the additional rotation imposed on the direction x of the pilot mode by the introduction of the bias function ξ(t).

Preferably, if the bias function ξ(t) is constant in absolute value, this constant absolute value being noted ξ_{cons}, each time the sign of the bias function ξ(t) is modified, which means at each instant tᵢ, the value θ_{biais} as output of the corrector module 50 is corrected by adding the opposite of twice the bias function at date t, in other words—2ξ(ti), over an integration time step of the integration module 504 starting from instant tᵢ.

This arrangement allows to limit the duration of the transient state linked to the change of direction of the additional rotation imposed, the measurement of the sought angular speed being carried out in steady state.

In particular, if we note K the gain of the gain module 503 and dt the integration time step of the integration module 504,

$${θ}_{biais} ( {t}_{i + 1} ) = {θ}_{biais} ( {t}_{i} ) + {\int }_{{t}_{i}}^{{t}_{i + 1}} ( δ ( t ) + {ξ}_{cons} ) K \cdot dt with δ ( t ) + {ξ}_{cons} = 0 in$$

steady state, that is, δ(tᵢ₊₁)=−ξ_{cons}

$${θ}_{biais} ( {t}_{i + 2} ) = {θ}_{biais} ( {t}_{i + 1} ) + {\int }_{{t}_{i}}^{{t}_{i + 1}} ( δ ( t ) - {ξ}_{cons} ) K \cdot dt with δ ( t ) - {ξ}_{cons} = 0 in$$

steady state, that is δ(tᵢ₊₂)=+ξ_{cons}.

The fact of adding the double of ξ_{cons} to the integration time step following the time tᵢ₊₁ allows to bring the estimated difference δ at the output of the precession module 25 more quickly to the zero value toward which it should converge at the end of the following time interval ΔT.

Finally, the invention relates to a computer program comprising instructions which lead the sensor 10 as described above to execute the method 100.

1. A gyroscopic measurement method by means of a sensor comprising a housing and a vibrating element able to vibrate relative to the housing in a plane of vibration attached to the housing simultaneously according to a direction of a pilot mode and according to a direction of a detection mode different from the direction of the pilot mode, the method comprising the following steps of:
a) servoing a first vibration amplitude of the vibrating element according to the direction of the pilot mode to a predetermined pilot amplitude, and a second vibration amplitude of the vibrating element according to the direction of the detection mode to a predetermined detection amplitude, and
b) determining an instantaneous angular speed of the housing relative to a sensitive axis of the sensor from measurements of the vibrations of the vibrating element and the pilot amplitude,
the method being characterized in that a predetermined bias is introduced into a measurement of an angular position of the direction of the pilot mode used to determine a biased force to be exerted on the vibrating element for servoing the first and/or second vibration amplitude,
the introduction of the predetermined bias causing a controlled rotation of the direction of the pilot mode in the plane of vibration,
the instantaneous angular speed of the housing being further determined from the predetermined bias.

2. The gyroscopic measurement method according to claim 1, wherein the predetermined bias is configured to cause rotation of the direction of the pilot mode by a predetermined angle alternately in a first direction and in a direction opposite to the first direction.

3. The gyroscopic measurement method according to claim 2, wherein the predetermined angle is equal to 90°.

4. The gyroscopic measurement method according to claim 1, wherein the detection amplitude is chosen to be zero.

5. The gyroscopic measurement method according to claim 1, in which the servoing step comprises:
a measurement of the vibrations of the vibrating element;
an estimation of a phase characteristic of the vibrations of the vibrating element according to the direction of the pilot mode from the results of the measurement;
a first estimate of a first force the direction of which is the direction of the pilot mode to be exerted on the vibrating element to servo the first amplitude from the results of the measurement and the estimated phase;
a second estimation of a second force the direction of which is the direction of the pilot mode to be exerted on the vibrating element to servo the second amplitude from the results of the measurement and the estimated phase;
introduction of the predetermined bias in the directions of the first force and the second force;
control of the biased force which is equal to the resultant of the first force and the second force after introduction of the predetermined bias in the directions of these two forces.

6. The gyroscopic measurement method according to claim 5, wherein the second force comprises only one component in phase with the vibrations of the vibrating element according to the direction of the pilot mode.

7. A gyroscopic sensor comprising a housing and a vibrating element able to vibrate relative to the housing in a plane of vibration attached to the housing simultaneously according to a direction of a pilot mode and according to a direction of a detection mode different from the direction of the pilot mode and configured to implement the steps of the method according to claim 1.

8. The gyroscopic sensor according to claim 7, comprising:
a first control module, configured to estimate a first force to be exerted according to the direction of the pilot mode to servo a first vibration amplitude of the vibrating element according to the direction of the pilot mode to a predetermined pilot amplitude;
a second control module, configured to estimate a second force to be exerted according to the direction of the detection mode to servo a second vibration amplitude of the vibrating element according to the direction of the detection mode to a predetermined detection amplitude;
a measurement module, configured to generate measurements of the vibrations of the vibrating element according to two directions of a reference frame attached to the housing, said two directions being contained in the vibration plane;
a command module, configured to determine a biased force to be exerted on the vibrating element to servo the first and/or second vibration amplitude, from the first force and the second force and from a biased angular position of the direction of the pilot mode in the reference frame attached to the housing which corresponds to an angular position of the direction of the pilot mode in the reference frame attached to the housing after introduction of a predetermined bias, and for exerting the biased force;
a bias device, configured to supply the biased angular position to the command module from measurements of the vibrations of the vibrating element according to the two directions of the reference frame attached to the housing and from the predetermined bias, the introduction of the predetermined bias being configured to cause a controlled rotation of the direction of the pilot mode in the plane of vibration when the biased force is exerted; and
a determination module, configured to determine an instantaneous angular speed of the housing relative to a sensitive axis of the sensor from measurements of the vibrations of the vibrating element, from the pilot amplitude and from the predetermined bias.

9. The gyroscopic sensor according to claim 8, wherein the bias device comprise:
a reference frame change module, configured to generate estimations of the vibrations of the vibrating element according to the direction of the pilot mode and the direction of the detection mode from measurements of the vibrations of the vibrating element according to the two directions of the reference frame attached to the housing supplied by the measurement module and from the biased angular position supplied by a correction module of the bias device;
a phase module, configured to receive as input, estimations of the vibrations of the vibrating element according to the direction of the pilot mode from the reference frame change module and to estimate a phase characterizing a position of the vibrating element according to the direction of the pilot mode at a current date;
a precession module, configured to receive estimations of the vibrations of the vibrating element according to the directions of the pilot mode and of the detection mode from the reference frame change module and the phase from the phase module, and supply as an output an estimated difference between the angular position of the direction of the pilot mode in the reference frame attached to the housing at the current date and a biased angular position previously supplied by the correction module, and
the correction module, configured to supply the biased angular position to the command module from the estimated difference, the correction module comprising:
i) a sum module, configured to add the predetermined bias to said estimated difference; and
ii) a feedback loop toward the reference frame change module, the feedback loop comprising a gain module and an integration module,
the correction module being configured so that the estimated difference converges to a zero value.

10. A computer program comprising instructions which cause a gyroscopic sensor comprising a housing and a vibrating element able to vibrate relative to the housing in a plane of vibration attached to the housing simultaneously according to a direction of a pilot mode and according to a direction of a detection mode different from the direction of the pilot mode and configured to implement the steps of the method according to claim 1 to execute the method according to claim 1.
